(19) United States
(12) Patent Application Publication
(10) Pub. No.: US 2016/0265910 A1
(43) Pub. Date: Sep. 15, 2016

(54) IN-SITU ANALYSIS OF ICE USING SURFACE ACOUSTIC WAVE SPECTROSCOPY

(71) Applicant: HALLIBURTON ENERGY SERVICES, INC., Houston, TX (US)

(72) Inventors: James M. Price, Spring, TX (US); David L. Perkins, The Woodlands, TX (US); Robert Atkinson, Conroe, TX (US); Li Gao, Katy, TX (US)

(73) Assignee: HALLIBURTON ENERGY SERVICES, INC., Houston, TX (US)

(21) Appl. No.: 14/772,115

(22) PCT Filed: Jul. 30, 2014
(86) PCT No.: PCT/US2014/048791

§ 371 Date: Sep. 2, 2015

(51) Int. Cl. G01B 17/02; G01N 29/46; G01N 29/24

(52) U.S. Cl. CPC G01B 17/02; G01N 29/2418; G01N 29/2462; G01N 29/46; G01N 2291/02854

(57) ABSTRACT

Systems and methods of in-situ measuring the physical properties of an integrated computational element (ICE) device using surface acoustic wave (SAW) spectroscopy during fabrication are provided. The system includes a measurement device having a pump source providing an excitation pulse generating a SAW on the outer surface of the ICE. The system provides a probe radiation to be interacted with the outer surface of the ICE device and to form an interacted radiation, and an optical transducer configured to receive the interacted radiation and form a signal. An analyzer receives the signal from the optical transducer and determines a property of a material layer on the outer surface of the ICE device, and a second measurement device using at least one of optical monitoring, ellipsometry, and optical spectroscopy, is configured to measure a second property in the ICE device.

### BACKGROUND

The present disclosure relates to optical thin-film fabrication and, more particularly, to systems and methods of in-situ characterization of film thickness, during optical thin-film fabrication for integrated computational element (ICE) devices.

In the field of thin-film device fabrication for optical purposes, multilayered thin-film devices designed to obtain specific spectral performances in ICE devices are common. Performance of ICE devices depends strongly on achieving accurate thickness values for each of the multiple layers stacked in the multi-layered thin-film device. Currently available optical techniques for in-situ measurement of a layer thickness are hampered by opaque and/or thick material layers. The reduced optical signal due to absorption and scattering by opaque or thick materials diminishes performance of state-of-the-art optical measurement techniques.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 illustrates an exemplary integrated computational element (ICE) device, according to some embodiments.

FIG. 2 illustrates an exemplary measurement system for in-situ measurements during fabrication of ICE devices, according to some embodiments.

FIG. 3 illustrates a side view of an exemplary system for in-situ analysis of ICE devices using surface acoustic wave (SAW) spectroscopy, according to some embodiments.

FIG. 4 illustrates a flow chart including steps in a method for in-situ analysis of an ICE device using SAW spectroscopy, according to some embodiments.

FIG. 5 illustrates a flow chart including steps in a method for in-situ analysis of an ICE device using SAW spectroscopy, according to some embodiments.

### DETAILED DESCRIPTION

The present disclosure relates to optical thin-film based integrated computational elements (ICE) and, more particularly, to systems and methods for in-situ measuring a film's properties during fabrication of an optical thin-film based ICE, using surface acoustic waves (SAWs).

The present disclosure provides improved systems and methods for measuring the thickness of material layers in optical devices such as ICE devices, during fabrication. A system as disclosed herein may include a chamber, a material source contained within the chamber, a substrate holder to support a multilayer stack of materials that form the ICE device, a measurement system, and a computational unit. The material source provides a material layer to the multilayer stack until a material layer thickness measured by the measurement system reaches a preselected value. As described herein, absorbance of a pump light in opaque or thick material layers generates a SAW on an outer surface of the stack. The SAW modulates the reflection of a probe radiation impinging on the surface of the material layer at an incident angle. In that regard, the SAW resembles a ripple propagating on the outer surface of the material layer producing a modulation on the reflectance properties of the material layer. The reflected intensity is measured (e.g., with a detector), and a SAW-induced modulation is analyzed to obtain the thickness of the material layer. In some embodiments, the reflected intensity measured from a SAW-induced modulation includes determining a density of the material layer. In some embodiments, the SAW resembles a ripple propagating on the outer surface of the material layer producing an interference pattern of the probe radiation. Features of the interference pattern as the SAW propagates through the outer surface may be spatially resolved and measured in time to obtain the thickness and density of the material layer.

Accordingly, embodiments as disclosed herein include methods for in-situ analysis of material layer thickness using SAW spectroscopy as described above. In some embodiments, SAW spectroscopy measurements are combined with other optical measurement techniques. Therefore, in-situ measurement techniques as disclosed herein may include a broad range of physical properties of the material layer, providing a more accurate description of the material layer stack in the ICE device. For example, a SAW spectroscopy measurement involves mechanical properties of the material layer, such as density (ρ), Young's modulus (κ), and Poisson ratio (ν). Other optical measurement techniques involve optical properties such as index of refraction (n), absorption coefficient (α), photo-elastic coefficients, thickness (d), and density (ρ). Values of measured using methods disclosed herein range from tens and hundreds of angstroms to over several micrometers. The combination of methods and techniques disclosed herein offer a measurement resolution as high as a few nanometers, or even less.

In that regard, SAW spectroscopy is complementary to other optical measurement techniques. For example, SAW spectroscopy benefits from the opacity and thickness of a material layer, while other optical techniques suffer. Thick layers of material consistent with embodiments as disclosed herein may range from half a micrometer or less (such as a few hundred nm) to a micrometer, or more. In some configurations, optical techniques such as ellipsometry or interferometry may be difficult to implement even for thin layers of materials. This is the case of metallic layers and certain opaque semiconductor materials. Accordingly, embodiments consistent with the present disclosure include the use of SAW spectroscopy for thickness measurements in metal layers and in opaque semiconductors.

ICE devices are a type of optical computing device or opticoanalytical device, and can be used to analyze and monitor a substance in real time. Such optical computing devices will often employ a light source emitting electromagnetic radiation that reflects or refracts from a substance and optically interacts with an optical processing element to determine quantitative and/or qualitative values of one or more physical or chemical properties of the substance. The optical element may be, for example, an integrated computational element (ICE), which may act as an optical interference filter based device that can be designed to operate over a continuum of wavelengths in the electromagnetic spectrum from the UV to mid-infrared (MIR) ranges, or any sub-set of that region. Electromagnetic radiation that optically interacts with the substance is changed and processed by the ICE and is read by a detector. An output of the detector is correlated to the physical or chemical property of the substance being analyzed.

An exemplary optical thin-film based ICE typically includes a plurality of optical layers consisting of various materials whose index of refraction and size (e.g., thickness) may vary between each layer. The design of an ICE (referred to herein as an “ICE design”) refers to the number and thicknesses of the respective layers of the ICE stack. The layers may be strategically deposited and sized to selectively pass predetermined fractions of electromagnetic radiation at different wavelengths configured to substantially mimic a regression vector corresponding to a particular physical or chemical property of interest of a substance. Accordingly, an ICE design will exhibit a transmission function that is weighed with respect to wavelength. As a result, the output light from the ICE conveyed to the detector is correlated to the physical or chemical property of interest for the substance.

Presently disclosed systems and methods may be suitable for the design and fabrication of ICE devices or “ICE cores.” However, it will be appreciated that the various disclosed systems and methods are equally applicable to fabrication of any thin-film used in thin-film applications. Such application areas and technology fields may include, but are not limited to, the oil and gas industry, food and drug industry, industrial applications, the mining industry, the optics industry, the eyewear industry, the electronics industry, and the semiconductor industry.

As used herein, the term “characteristic” refers to a chemical, physical (such as mechanical), optical, electrical property of a substance. The characteristic of a substance may include a quantitative or qualitative value of one or more chemical constituents or compounds present therein, or any physical property associated therewith. Such chemical constituents and compounds may be referred to herein as “analytes.” Illustrative characteristics of a substance that can be detected with the ICE devices described herein can include, for example, chemical composition (e.g., identity and concentration in total or of individual components), phase presence (e.g., gas, oil, water, etc.), impurity content, pH, alkalinity, viscosity, density, ionic strength, total dissolved solids, salt content (e.g., salinity), porosity, opacity, bacteria content, total hardness, transmittance, combinations thereof, state of matter (solid, liquid, gas, emulsion, mixtures, etc.), and the like.

As used herein, the term “substance,” or variations thereof, refers to at least a portion of matter or material of interest to be tested or otherwise evaluated using the ICE devices described herein. The substance includes the characteristic of interest, as defined above. The substance may be any fluid capable of flowing, including particulate solids, liquids, gases (e.g., air, nitrogen, carbon dioxide, argon, helium, methane, ethane, butane, and other hydrocarbon gases, hydrogen sulfide, and combinations thereof), slurries, emulsions, powders, drilling fluids, glasses, mixtures, combinations thereof, and may include, but is not limited to, aqueous fluids (e.g., water, brines, etc.), non-aqueous fluids (e.g., organic compounds, hydrocarbons, oil, a refined component of oil, petrochemical products, and the like), acids, surfactants, biocides, bleaches, corrosion inhibitors, foamers and foaming agents, breakers, scavengers, stabilizers, clarifiers, detergents, a treatment fluid, fracturing fluid, a formation fluid, or any oilfield fluid, chemical, or substance as found in the oil and gas industry. The substance may also refer to a solid material such as, but not limited to, rock formations, concrete, solid wellbore surfaces, and solid surfaces of any wellbore tool or projectile (e.g., balls, darts, plugs, etc.).

As used herein, the term “electromagnetic radiation” refers to radio waves, microwave radiation, terahertz, infrared and near-infrared radiation, visible light, ultraviolet light, X-ray radiation and gamma ray radiation.

As used herein, the term “optically interact,” or variations thereof, refers to the reflection, transmission, scattering, diffraction, or absorption of electromagnetic radiation either on, through, or from one or more processing elements (i.e., an ICE or other Integrated Computational Element(s) not characterized as an optical thin-film based device), a substance being analyzed by the processing elements, or a polarizer. Accordingly, optically interacted light refers to electromagnetic radiation that has been reflected, transmitted, scattered, diffracted, or absorbed by, emitted, or re-radiated, for example, using a processing element, but may also apply to optical interaction with a substance or a polarizer.

To facilitate a better understanding of the distinguishing features of the present disclosure, the following examples of representative embodiments and advantages are given. In no way should the following examples be read to limit, or to define, the scope of the disclosure.

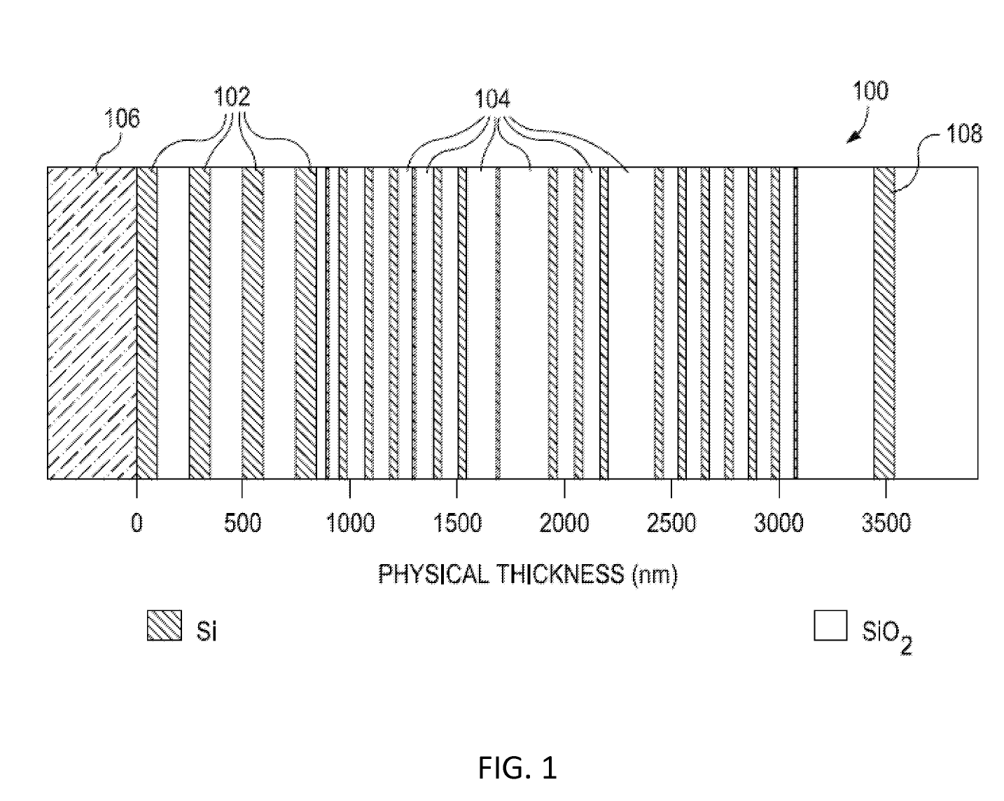

Referring to FIG. 1, illustrated is an exemplary ICE 100, according to one or more embodiments of the present disclosure. As illustrated, ICE 100 may include a plurality of alternating layers 102 and 104, such as silicon (Si) and SiO2, respectively. In general, these layers 102, 104 consist of materials whose refraction coefficient is high and low, respectively. The refraction coefficient as used hereinafter is the real part of the complex index of refraction. Other examples of materials might include niobia and niobium, germanium and germania, MgF₂, SiO₂, and other high and low index materials known in the art. In some embodiments, layers 102 and 104 may include thin metal layers, and opaque semiconductor materials such as SiC and the like. Layers 102, 104 may be strategically deposited on an optical substrate 106. In some embodiments, optical substrate 106 is BK-7 optical glass. In other embodiments, the optical substrate 106 may be another type of optical substrate, such as quartz, sapphire, silicon, germanium, zinc selenide, zinc sulfide, or various plastics such as polycarbonate, polymethylmethacrylate (PMMA), polyvinylchloride (PVC), diamond, ceramics, combinations thereof, and the like.

At the opposite end (e.g., opposite optical substrate 106 in FIG. 1), ICE 100 may include a layer 108 that is generally exposed to the environment of the device or installation, and may be able to detect a sample substance. The number of layers 102, 104 and the thickness of each layer 102, 104 are determined from the spectral attributes acquired from a spectroscopic analysis of a characteristic of the substance being analyzed using a conventional spectroscopic instrument. The spectrum of interest of a given characteristic typically includes any number of different wavelengths.

It should be understood that ICE 100 in FIG. 1 does not in fact represent any particular ICE configured to detect a specific characteristic of a given substance, but is provided for illustration purposes only. Consequently, the number of layers 102, 104 and their relative thicknesses, as shown in FIG. 1, bear no correlation to any particular substance or characteristic thereof. Nor are layers 102, 104 and their relative thicknesses necessarily drawn to scale, and therefore should not be considered limiting of the present disclosure.

In some embodiments, the material of each layer 102, 104 can be doped or two or more materials can be combined in a manner to achieve the desired optical characteristic. In addition to solids, the exemplary ICE 100 may also contain liquids and/or gases, optionally in combination with solids, in order to produce a desired optical characteristic. In the case of gases and liquids, ICE 100 can contain a corresponding vessel (not shown), which houses the gases or liquids. Exemplary variations of ICE 100 may also include holographic optical elements, gratings, piezoelectric, light pipe, and/or acousto-optic elements, for example, that can create transmission, reflection, and/or absorptive properties of interest.

The multiple layers 102, 104 may exhibit different refractive indices. By properly selecting the materials of layers 102, 104 and their relative thickness and spacing, ICE 100 may be configured to selectively pass/reflect/refract/absorb predetermined fractions of electromagnetic radiation at different wavelengths. Each wavelength is given a predetermined weighting or loading factor. The thickness and spacing of layers 102, 104 may be determined using a variety of approximation methods from the spectrum of the characteristic or analyte of interest. These methods may include inverse Fourier transform (IFT) of the optical transmission spectrum and structuring ICE 100 as the physical representation of the IFT. The approximations convert the IFT into a structure based on known materials with constant refractive indices.

The weightings that layers 102, 104 of ICE 100 apply at each wavelength may be set to the regression weightings described with respect to a known equation, data, or spectral signature. For instance, when electromagnetic radiation interacts with a substance, unique physical and chemical information about the substance may be encoded in the electromagnetic radiation that is reflected from, transmitted through, or radiated from the substance. This information is often referred to as the spectral “fingerprint” of the substance. ICE 100 may be configured to perform the dot product of the received electromagnetic radiation and the wavelength dependent transmission function of the ICE 100. The wavelength dependent transmission function of ICE 100 is dependent on the material refractive index of each layer, the number of layers 102, 104 and thickness of each layer 102, 104. Thus, it can be appreciated that performing optical measurements on layers 102, 104 during fabrication may indicate proper or improper refractive indexes and layer 102, 104 thicknesses, and further enable adjustments as necessary for proper operation of ICE 100 upon fabrication completion.

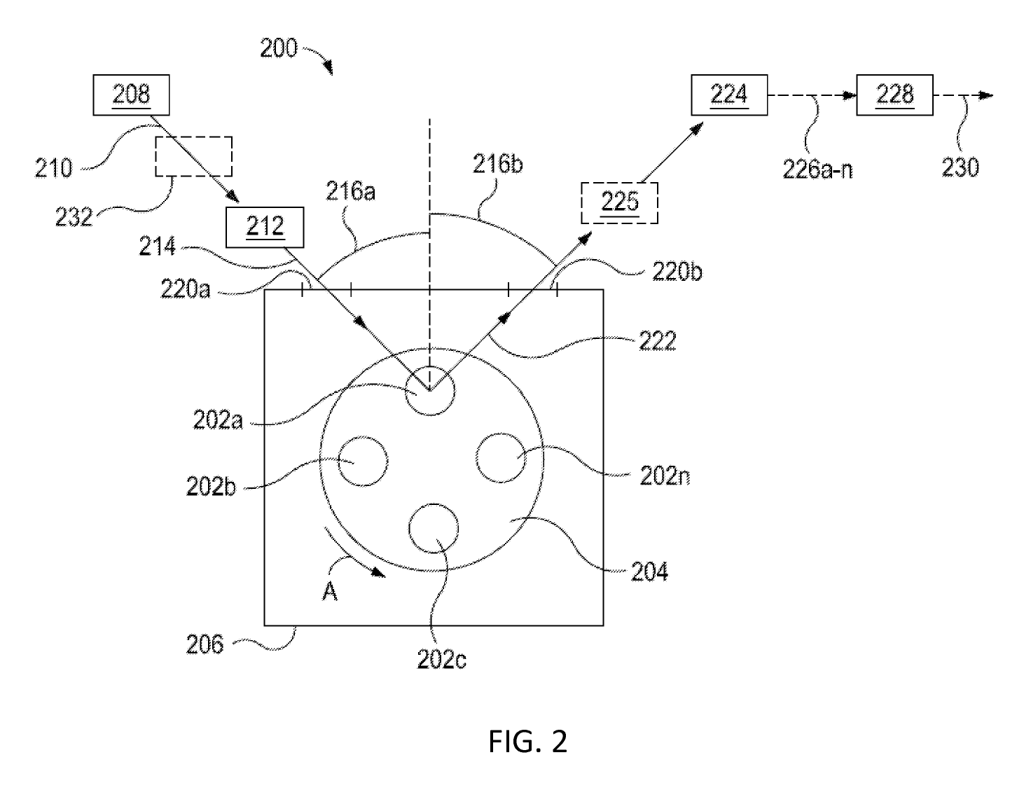

FIG. 2 illustrates an exemplary measurement system 200 for in-situ measurements during fabrication of ICE devices, according to one or more embodiments. System 200 performs non-destructive measurements during ICE device fabrication to find the thickness of each of the deposited layers in the ICE stack. As illustrated, measurement system 200 is configured to perform optical measurement techniques based on SAW spectroscopy. According to some embodiments, measurement system 200 may further be configured to perform other optical measurement techniques such as ellipsometry, optical spectroscopy, and interferometry in addition to SAW spectroscopy. Optical spectroscopy measurement techniques may include absorption spectroscopy and reflection spectroscopy. More particularly, measurement system 200 may be configured to perform SAW spectroscopy measurements on one or more ICE devices 202 (shown as 202a, 202b, 202c, . . . 202n) arranged on an assembly 204 within a fabrication housing 206. Each ICE device 202a-n may be somewhat similar to the ICE device 100 of FIG. 1, and therefore will not be described again in detail.

Measurement system 200 may be configured to measure various parameters of ICE devices 202a-n as they are built within fabrication housing 206. For instance, measurement system 200 may be configured to estimate or otherwise determine the thickness (d), density (ρ), or refractive index (n) of each layer 102, 104 (FIG. 1) as it is deposited on its corresponding substrate 106 (cf. FIG. 1) for each ICE device 202a-n. One of skill in the art will appreciate that, while ICE devices 202a-n are depicted and discussed herein, ICE devices 202a-n may be replaced and the techniques disclosed herein may be equally applied to optical measurements of fluids (i.e., gas(es) or liquid(s)) or SAW spectroscopy of thin-film devices in general.

Measurement system 200 may include a light source 208 (hereafter “source 208”) capable of emitting or generating electromagnetic radiation 210, as defined herein. Source 208 may be a laser operating at a fixed wavelength. In some embodiments, source 208 may be a laser capable of “tuning” or adjusting the output wavelength band of the electromagnetic radiation 210 during operation. In one embodiment, source 208 may include an optical parametric oscillator (OPO). In some embodiments, source 208 may be a continuous wave (CW) source, or a pulsed laser forming a pulsed beam having a selected repetition rate. Further embodiments include a single wavelength laser or a broadband lamp as source 208. In some embodiments, source 208 is pulsed so that electromagnetic radiation 210 may include electromagnetic pulses. Accordingly, electromagnetic radiation 210 may pass through or otherwise interact with an optical element 212, thereby producing probe radiation 214. Optical element 212 may be a polarizer, a retarder plate for rotating the polarization of electromagnetic radiation 210 (e.g., a quarter- or half-wave plate), an attenuator, or a filter to select a specific bandwidth of electromagnetic radiation 210. The wavelength of probe radiation 214 may be adjusted according to a spatial resolution desired for the measurement. Accordingly, a shorter probe wavelength may provide a higher spatial resolution relative to a longer probe wavelength.

In some embodiments, fabrication housing 206 may include or otherwise provide a first sample window 220a and a second sample window 220b. Fabrication housing 206 may be a fabrication chamber or otherwise a chamber where layers 102, 104 (FIG. 1) of each ICE device 202a-n are progressively built or deposited to predetermined or desired thicknesses. Sampling windows 220a,b may be made from a variety of transparent, rigid or semi-rigid materials that are configured to allow transmission of probe radiation 214 therethrough. For example, sampling windows 220a,b may be made of glasses, plastics, semiconductors, crystalline materials, polycrystalline materials, hot or cold-pressed powders, combinations thereof, or the like.

In at least one embodiment, assembly 204 within the fabrication housing 206 may be generally circular and capable of rotation about a central axis, for example, in the direction A. ICE devices 202a-n may be radially disposed about assembly 204 for rotation therewith. Assembly 204 may also be capable of rotation in a direction opposite of direction A. While assembly 204 is depicted as containing multiple ICE devices 202a-n, it will be appreciated that in some embodiments, assembly 204 may include a single ICE device 202a-n.

Source 208 emits electromagnetic radiation 210 in a direction towards the fabrication housing 206 and ICE devices 202a-n at a first angle 216a from an axis normal to ICE devices 202. In exemplary operation, probe radiation 214 may be transmitted through the first sample window 220a to optically interact with ICE devices 202a-n, thereby producing an optically interacted radiation 222 reflected therefrom. Interacted radiation 222 may be emitted from each ICE device 202a-n at a second angle 216b from the central axis and exit fabrication housing 206, as depicted, through a second sampling window 220b. Alternatively, optically interacted radiation 222 may exit fabrication housing 206 back through first sample window 220a.

Interacted radiation 222 is conveyed in a direction towards an optical element 225 and an optical transducer 224. In some embodiments, optical element 225 includes one or more of a polarizer, a retarder plate (such as a half-wave plate, or a quarter-wave plate), and a filter. Optical element 225 may be included to select a portion of optically interacted radiation 222 of interest for an optical measurement.

Optical transducer 224 may be, for example, a thermal detector, such as a thermopile or photoacoustic detector, a semiconductor detector, a piezoelectric detector, a charge coupled device (CCD) detector, a video or array detector, a split detector, a photon detector (such as a photomultiplier tube), photodiodes, combinations thereof, or the like, or another detector known to those skilled in the art. Optical transducer 224 may be capable of measurements over a spectral region similar to that capable of being output from source 208.

In some embodiments, measurement system 200 may include an intensity filter 232 arranged along the optical path between the source 208 and the polarizer 212. In other embodiments, intensity filter 232 may be arranged at any location along the optical path in between source 208 and optical transducer 224, such as directly preceding optical transducer 224. Intensity filter 232 may be configured to reduce the intensity of the electromagnetic radiation 210 or optically interacted radiation 222 prior to detection by optical transducer 224. Example intensity filters may include, but are not limited to, a physical mask, an aperture, or a neutral density (ND) filter. Advantageously, this power or intensity reduction by intensity filter 232 may prevent oversaturation and possible damage to optical transducer 224, while still allowing the full optical spectra of light to pass through.

Upon detecting optically interacted radiation 222, optical transducer 224 may generate corresponding output signals 226a-n related to each ICE device 202a-n. Output signals 226a-n may be in the form of a voltage, current, or combination thereof representing the intensity of the optically interacted radiation 222 as a function of time. Accordingly, the intensity of optically interacted radiation 222 may include probe radiation 214 reflected or diffracted at angle 216b, and modulated by a SAW induced on an outer surface of each of ICE devices 202a-n.

In some embodiments, output signals 226a-n are received by a signal processor 228 communicably coupled to optical transducer 224. Signal processor 228 may be a computer including a processor and a machine-readable storage medium having instructions stored thereon, which, when executed by signal processor 228, cause measurement system 200 to perform operations such as determining a property of ICE devices 202a-n. The signal processor 228 may be configured to provide a resulting output signal 230 in real-time or near real-time, either wired or wirelessly, to an operator for consideration.

More generally, system 200 may be used in combination with any optical technique to monitor a thickness of each individual film layer during ICE fabrication. Optical techniques available to use in combination with system 200 include, but are not limited to, ellipsometry, infra-red (IR) spectroscopy, transmission spectroscopy, and optical monitoring systems (OMS) for in-situ characterization of ICE device 202. In some embodiments, system 200 may be complemented with a mechanical technique using a crystal sensor method for in-situ characterization of film thickness and density. For example, system 200 may include measurements of layer thickness and material density performed with quartz crystal microbalances. Accordingly, embodiments disclosed herein include in-situ characterization of film thickness using SAW spectroscopy in combination with other measurement techniques.

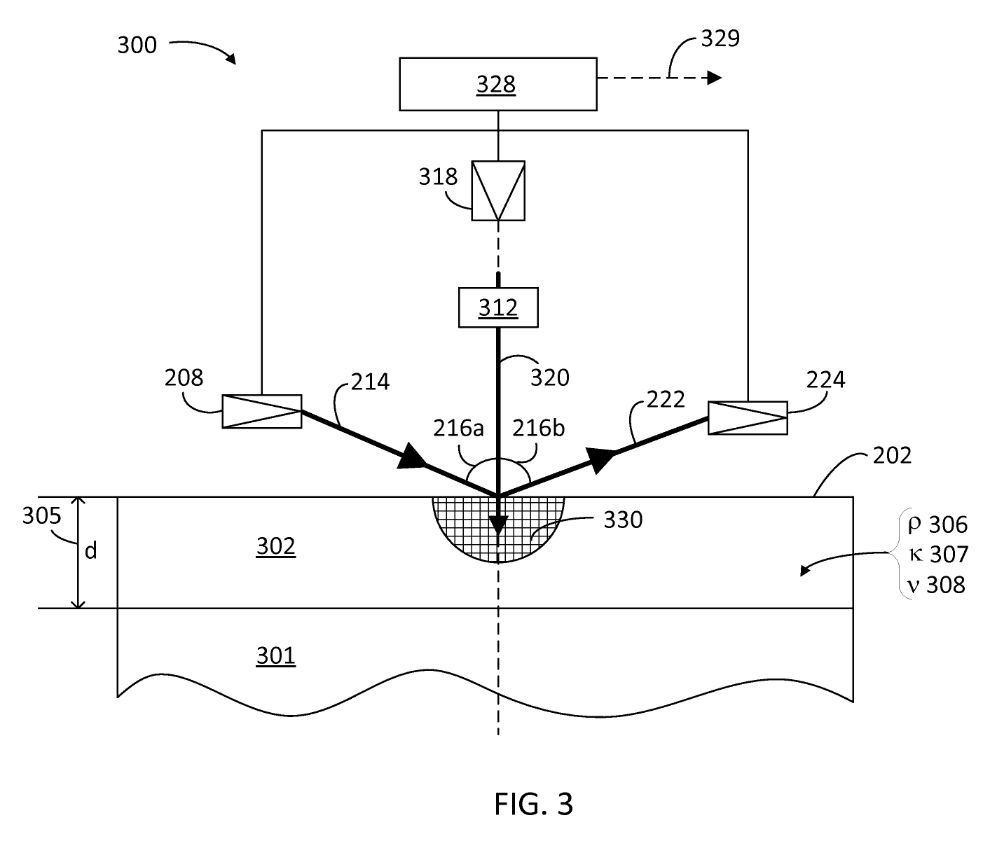

FIG. 3 illustrates a side view of an exemplary system 300 for in-situ analysis of ICE devices using Surface Acoustic Wave (SAW) spectroscopy, according to some embodiments. Accordingly, system 300 may complement alternative techniques for in-situ, non-destructive, film stack analysis during ICE device fabrication, such as those generally described in relation to FIG. 2, above. System 300 is similar to system 200 described in detail above, further including a pump source 318 that generates a pump beam 320 impinging upon ICE device 202. In some embodiments, system 300 performs modulation spectroscopy techniques to measure relevant properties of a substrate, such as thickness 305 (d), density 306 (ρ), or Young's modulus 307 (κ). Pump source 318 generates pump beam 320 at an angle close to normal incidence on ICE device 202. Pump beam 320 includes pulses of electromagnetic radiation, which are absorbed in outer material layer 302 or in a subjacent material layer 301. In some embodiments, it may be desirable to avoid ablation of material layer 302 by pump beam 320, therefore an attenuator 312 may be used to regulate the intensity of pump beam 320. In FIG. 3, probe source 208, probe radiation 214, interacted beam 222, and optical transducer 224 are as described in detail above with reference to FIG. 2. Probe radiation 214 may be used in more than one optical measurement such as SAW spectroscopy, ellipsometry, or optical spectroscopy. Some embodiments of system 300 include probe radiation 214 impinging on approximately the same spot on ICE device 202 where pump beam 320 impinges.

As illustrated in FIG. 3, probe radiation 214 impinges on ICE device 202 at angle 216a, which may be relatively large compared with the near normal incidence angle of pump beam 320. Accordingly, first angle 216a may be a grazing angle selected to reduce optical losses for interacted beam 222. In some embodiments, optical transducer 224 includes a plurality of photo-detectors, such as a linear array or a two-dimensional array. Accordingly, optical transducer 224 may include a charge-coupled device (CCD) or a complementary metal-oxide-semiconductor (CMOS) array detector. Thus, in some embodiments optical transducer 224 may be configured to measure a diffraction pattern of interacted beam 222.

The opaque material in outer material layer 302 or in subjacent material layer 301 absorbs the energy from pump beam 320 and generates a strain pulse 330. Strain pulse 330 locally distorts the refractive index as it propagates through materials layers 301 and 302, forming a SAW on the outer surface of material layer 302. The SAW modulates interacted radiation 222 off the outer surface of material layer 302. The modulation induced by the SAW on interacted radiation 222 may include a reflectivity modulation as the outer surface of material layer 302 buckles under the SAW. In some embodiments, the modulation induced by the SAW on interacted radiation 222 may include a diffraction effect. Accordingly, the SAW may be configured to buckle the outer surface of material layer 302 and form a localized diffraction grating. In that regard, probe radiation 214 may include a visible wavelength (VIS, with wavelengths between approximately 450 nm to approximately 750 nm). In other embodiments, probe radiation 214 may include an ultraviolet wavelength (UV, with wavelength less than approximately 450 nm), or any other wavelength that is efficiently reflected or diffracted by material layer 302. Optical transducer 224 measures a time-dependent signal from interacted radiation 222. A signal processor 328 similar to signal processor 228 provides a resulting output signal including thickness and/or mechanical properties of material layer 302. In that regard, signal processor 328 may be configured to obtain a Fourier transform of the signal provided by optical transducer 224 in time. The Fourier transform of the signal provided by optical transducer 224 in time includes features indicating a thickness (d), a density (ρ), a Young's modulus (κ), and a Poisson's ratio (ν) of an outer layer of material deposited on each of ICE devices 202a-n. Output signal 329 may include or otherwise be indicative of one or more of layer thickness (d), density (ρ), Young's modulus (κ), Poisson's ratio (ν), and refractive index approximations for each ICE devices 202a-n. In some embodiments, signal processor 328 may be configured to adjust the pulses in pump beam 320 so that the time measurement from optical transducer 224 includes an interaction time between two consecutive pulses.

Pump source 318 may include an optical pump such as a mode-locked ultra-short laser that generates pump pulses to impinge on outer material layer 302 at near normal incidence. A mode-locked ultra-short laser includes short, high-energy pulses of radiation at a repetition rate ranging from a few kilo-Hertz (kHz) up to several hundreds of mega-Hertz (MHz). Further, according to some embodiments, the pump pulse may include electromagnetic radiation having similar wavelength and bandwidth as the probe radiation, but at a higher intensity. Accordingly, pump source 318 may be a femto-second or a pico-second mode-locked laser providing light pulses from about 100 femto-seconds (fs, 1 fs=10⁻¹⁵ s) or less up to approximately a few pico-seconds (ps, 1 ps=10⁻¹² s), or more.

Accordingly, pump beam 320 excites strain pulse 330 in ICE device 202 at the selected repetition rate. In some embodiments, strain pulse 330 includes a longitudinal strain wave that propagates through material layer 302 and reflects off the interface between subjacent material layer 301 and outer material layer 302. For example, a difference in material density between material layers 301 and 302 may result in a reflection of strain wave 330 at the interface between the two. The interference of a propagating strain wave 330 with its reflection off the interface between material layers 301 and 302 generates a SAW on an outer surface of material layer 302. The SAW has features associated with a thickness 305 (d), a density 306 (ρ), a Young's modulus 307 (κ), and a Poisson ratio 308 (ν) of material layer 302. Some of the relevant features of the SAW may include a periodicity (spatial and temporal), a depth (peak-to-trough amplitude), a phase, and a transverse and longitudinal propagation velocity. In some embodiments, a lower measurement limit in thickness depends on a wavelength of the SAW generated by probe beam 320. Moreover, in some embodiments, it may be desired to have pump beam 320 at near normal incidence so that the SAW propagates homogeneously in the plane of material layer 302 from the point of incidence of pump beam 320.

For example, in some embodiments a temporal profile of the SAW is associated with 305. In some embodiments, a value of ‘ρ’ 306 may be obtained, provided ‘κ’ 307 and ‘ν’ 308 are known, and a SAW property is measured at multiple incident pump power values. Accordingly, a time trace of the signal collected by optical transducer 224 indicating the intensity of interacted radiation 222 includes relevant SAW features. In some embodiments, a Fourier transform of the time trace of the signal from optical transducer 224 produces at least one frequency component having a time delay value associated with 305. The strength of at least one Fourier transform component may also be associated with ‘ρ’ 306, ‘κ’ 307, and with ‘ν’ 308.

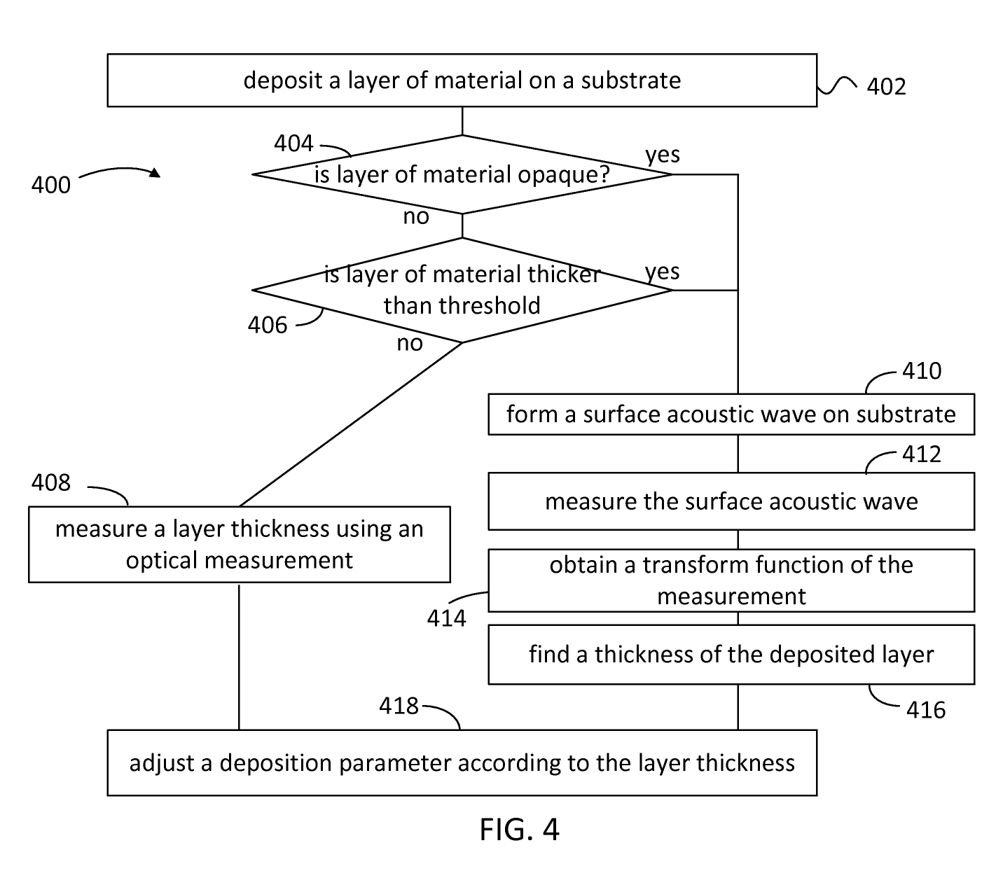

FIG. 4 illustrates a flow chart including steps in a method 400 for in-situ analysis of an ICE device using SAW spectroscopy, according to some embodiments. Embodiments of method 400 may include performing the steps illustrated in FIG. 4 in any order or sequence, and not limited to the specific sequence illustrated in FIG. 4. Moreover, embodiments of method 400 consistent with the present disclosure may include employing only one of the steps illustrated in FIG. 4, and not the others. Method 400 may be performed by a system for fabricating an ICE device consistent with embodiments disclosed herein (e.g., systems 200 and 300, and ICE device 202, cf. FIGS. 2-3). Accordingly, the system in method 400 may include a probe radiation incident at a first angle onto a substrate, and an interacted radiation emerging from the substrate at a second angle (e.g., probe radiation 214, first angle 216a, interacted radiation 222, and second angle 216b, cf. FIGS. 2 and 3). In some embodiments, the system in method 400 includes a pump pulse from a high-energy laser (e.g., pump pulse 320, cf. FIG. 3) inducing a SAW on a surface of the ICE device. Furthermore, the system in method 400 may include an optical transducer configured to measure the interacted radiation (e.g., optical transducer 224, cf. FIGS. 2-3). In some embodiments, the probe radiation in method 400 is used in any of a plurality of optical measurements performed during fabrication of the ICE device.

Furthermore, the system in method 400 may include a signal processor including processor circuits and memory (e.g., signal processors 228 and 328, cf. FIGS. 2-3). At least one memory circuit in the memory may include data and commands which, when executed by the signal processor, cause the signal processor to perform at least one of the steps in method 400. In some embodiments, the memory circuit stores a recorded trace of a signal from an optical transducer (e.g., optical transducer 224, cf. FIGS. 2 and 3). Moreover, the memory circuit may include a model having instructions, which, when executed by the signal processor, cause the processor circuit to perform a Fourier transform from the recorded trace. Using at least one of the Fourier transform components and a SAW propagation model, the signal processor determines at least one of a layer thickness (d), a material density (ρ), a Young's modulus (κ), and a Poisson ratio (ν) of a material layer deposited on the ICE device.

Step 402 includes depositing a layer of material on a substrate. The material layer may be one of a plurality of material layers in the ICE device. Step 404 includes determining whether the layer of material is opaque. The opacity of the layer of material is related to the degree of absorption of electromagnetic radiation by the material. Accordingly, in some embodiments the opacity of a material depends on the wavelength and bandwidth of an electromagnetic radiation used to study the material. In that regard, determining the opacity of the layer of material in step 404 depends on the probe radiation used. Examples of optical measurements include, but are not limited to, spectroscopy, ellipsometry and interferometry. For example, in some embodiments an ellipsometry measurement may include a material layer that is transparent to the probe radiation. Spectroscopy measurements may include any one of absorption spectroscopy, reflection spectroscopy, or transmission spectroscopy.

Step 406 includes determining whether the layer of material is thicker than a threshold. In some embodiments, step 406 may include determining that a signal received from the interacted radiation is lower than a limit value. The limit value may be related to a detection limit of the optical transducer used in the optical measurement. In some embodiments step 406 includes determining the threshold based on a wavelength and a bandwidth of the interacted radiation and the detection limit of the optical transducer in the optical measurement. Further, according to some embodiments, the threshold in step 406 includes finding a limit value for thickness measurements based on estimating a wavelength of the SAW generated by the pump pulse.

Step 408 includes measuring a layer thickness using an optical measurement technique when it is determined that the material layer is not opaque. In some embodiments, step 408 is performed when it is determined that the material layer is thinner than the threshold. In some embodiments, step 408 includes performing at least one of an ellipsometry measurement, a spectroscopy measurement, and an interferometry measurement. Performing a spectroscopy measurement in step 408 may include performing at least one of a reflectance spectrometry, a transmission spectrometry, and an absorbance spectrometry. In some embodiments, step 408 may include using the probe radiation to perform the optical measurement.

Step 410 includes forming a SAW on a substrate. More particularly, step 410 may include exciting the deposited layer of material on the substrate with a high energy pump pulse. In some embodiments, step 410 includes directing an ultra-short laser pulse, such as a femto-second or a pico-second laser pulse to the substrate. In some embodiments, step 410 includes directing the pump pulse at near normal incidence relative to the substrate. Further, in some embodiments step 410 includes selecting a wavelength and a bandwidth for the electromagnetic radiation in the pump pulse such that absorption in the layer of material is maximized. In embodiments consistent with the present disclosure, step 410 includes using a pump pulsed at a repetition rate. The repetition rate may be adjusted according to an expected thickness range (d), an expected or known density range (ρ), an expected or known Young's modulus (κ), and an expected or known Poisson ratio (ν) of the layer of material.

Step 412 includes measuring a SAW. Accordingly, step 412 may include measuring a SAW feature such as a periodicity (spatial and temporal), a depth (peak-to-trough amplitude), a phase, or propagation velocities, described above. In some embodiments, step 412 includes measuring a spatial distribution of the SAW. Accordingly, step 412 may include obtaining a diffraction pattern of the interacted radiation when the optical transducer is a detector array. More particularly, step 412 may include obtaining a time-dependent interference signal from the reflection or diffraction of the probe radiation.

Step 414 includes obtaining a transform function of the SAW measurement. More particularly, step 414 may include obtaining a Fourier transform of a recorded time trace measurement of a reflectance of the probe beam, as measured by the optical transducer. Moreover, in some embodiments step 414 includes obtaining a spatial Fourier transform of a diffraction pattern of the interacted beam obtained by the optical transducer.

Step 416 includes finding a thickness of the deposited layer, which may include finding the thickness of the deposited layer based at least on a Fourier component of the recorded time trace measurement of the reflectance of the probe beam. In some embodiments step 416 includes further determining the material density (ρ), the material's Young's modulus (κ), and/or the material's Poisson ratio (ν), and using a model for SAW propagation through the ICE stack. More generally, some embodiments may use at least one Fourier component and a model for SAW propagation in the material to determine any one of the thickness (d), the density (ρ), the Young's modulus (κ), or the Poisson ratio (ν) of the layer of material, or any combination thereof.

Step 418 includes adjusting a deposition parameter according to the layer thickness, which may include reducing or increasing a deposition rate. More specifically, step 418 may include stopping a deposition of a layer of material. Further, according to some embodiments, step 418 may include depositing a specific ion dose in the layer of material to adjust an optical property of the layer of material. In some embodiments, step 418 includes updating the model for SAW propagation in an outer surface of the ICE stack with at least one of the thickness (d), density (ρ), Young's modulus (κ), or Poisson ratio (ν) of the deposited layer of material.

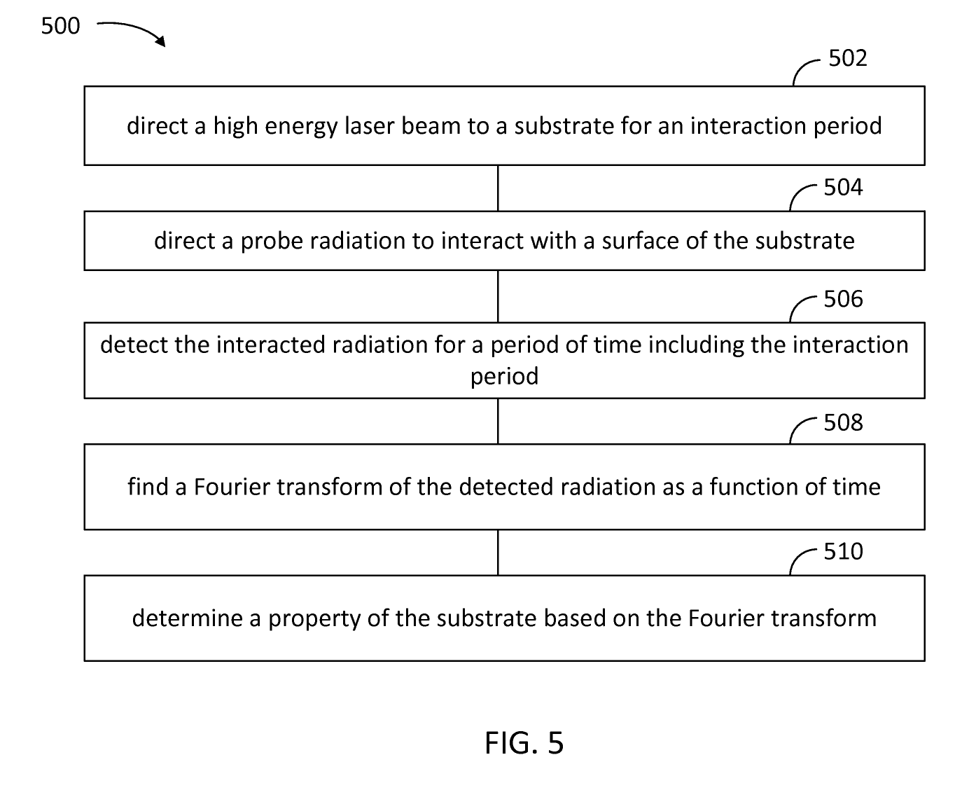

FIG. 5 illustrates a flow chart including steps in a method 500 for in-situ analysis of an ICE device using SAW spectroscopy, according to some embodiments. Embodiments of method 500 may include performing the steps illustrated in FIG. 5 in any order or sequence, and not limited to the specific sequence illustrated in FIG. 5. Moreover, embodiments of method 500 consistent with the present disclosure may include employing only one of the steps illustrated in FIG. 5, and not the others. Method 500 may be performed by a system for fabricating an ICE device consistent with embodiments disclosed herein (e.g., systems 200 and 300, and ICE device 202, cf. FIGS. 2-3). Accordingly, the system in method 500 may include a probe radiation incident at a first angle onto a substrate, and an interacted radiation emerging from the substrate at a second angle (e.g., probe radiation 214, first angle 216a, interacted radiation 222, and second angle 216b, cf. FIG. 2). In some embodiments, the system in method 500 includes a pump pulse (e.g., pump pulse 320, cf. FIG. 3) to induce a SAW on an outer surface of the ICE device. Furthermore, the system in method 500 may include an optical transducer configured to measure the interacted radiation (e.g., optical transducer 224, cf. FIGS. 2-3). In some embodiments, the probe radiation in method 500 is used in any of a plurality of optical measurements performed during fabrication of the ICE device.

Furthermore, the system in method 500 may include a signal processor including processor circuits and memory (e.g., signal processors 228 and 328, cf. FIGS. 2-3). At least one memory circuit in the memory may include data and commands which, when executed by the signal processor, cause the signal processor to perform at least one of the steps in method 500. In some embodiments, the memory circuit stores a recorded trace of a signal from an optical transducer (e.g., optical transducer 224, cf. FIGS. 2 and 3). Moreover, the memory circuit may include a model having instructions, which, when executed by the signal processor, causes the processor circuit to perform a Fourier transform from the recorded trace. Using at least one of the Fourier transform components and a SAW propagation model, the signal processor determines at least one of a layer thickness (d), a material density (ρ), and a Young's modulus (κ) of a material layer deposited on the ICE device.

Step 502 includes directing a high-energy laser beam to a substrate for an interaction period. In some embodiments, the high-energy laser beam may be a continuous wave (CW) laser beam. In some embodiments, the high-energy laser beam in step 502 may be the pump pulse operating at a selected repetition rate. Accordingly, step 502 may include directing the high-energy laser beam to the substrate at near normal incidence relative to an outer surface of the substrate. In some embodiments, step 502 includes determining the interaction period to be greater than a time that it takes a strain pulse to propagate through an outer layer of material in the substrate. For example, the interaction period may be greater than the time it takes a longitudinal strain pulse to travel across an expected thickness of the outer material layer, reflect off an interface with a subjacent material layer, and travel back to an outer surface of the outer material layer. Accordingly, in some embodiments step 502 includes selecting the interaction period as an integer multiple of the time it takes the longitudinal strain pulse to travel back and forth across the thickness of the outer material layer. In some embodiments, step 502 may include selecting a pulse repetition rate so that a time interval between subsequent pulses includes the interaction period.

Step 504 includes directing a probe radiation to reflect from a surface of the substrate. More particularly, step 504 may include directing the probe radiation at the first angle onto the substrate. Furthermore, in some embodiments step 504 includes directing a CW beam including the probe radiation to reflect from the surface of the substrate. Step 506 includes detecting the interacted radiation for a period of time including the interaction period. Step 506 includes detecting the interacted radiation emerging from the substrate. In some embodiments, step 506 includes using the optical transducer to measure the interacted radiation. Accordingly, step 506 may include synchronizing the optical transducer with the pulse repetition rate of the pump pulse.

Step 508 includes finding a Fourier transform of the detected reflection as a function of time. In some embodiments, step 508 includes using the signal processor to perform the Fourier transform of the detected reflection as a function of time. In some embodiments, step 508 includes performing a spatial Fourier transform of a signal provided by a detector array. Step 510 may include determining a property of the substrate based on the Fourier transform. In some embodiments, step 510 includes using the signal processor to perform operations on at least one component of the Fourier transform of the detected signal as a function of time. Step 510 may further include using a model for SAW propagation to determine a thickness (d), a density (ρ), a Young's modulus (κ), and a Poisson ratio (ν) of a layer of material based on at least a feature of the detected reflection as a function of time. Accordingly, a model of SAW propagation on an outer surface of the ICE device may include details of a plurality of material layers. The plurality of material layers may include an outer most material layer being deposited on the ICE device, and at least one subjacent material layer. Thus, in some embodiments, step 510 may include determining at least one of a thickness (d), a density (ρ), a Young's modulus (κ), and a Poisson ratio (ν) of at least one of the subjacent layers in the ICE device. Further according to some embodiments, step 510 may include updating the model with the most recent measurements and values of thickness (d), density (ρ), Young's modulus (κ), and Poisson ratio (ν) of the outermost material layer in the model. Accordingly, the updated model including new values of the physical properties of the outer most material layer is used when a new material layer is deposited on the ICE device.

In step 510, the feature of the detected signal as a function of time may include a frequency and an amplitude of at least one Fourier component of the Fourier transform. In some embodiments, the feature of the detected signal as a function of time may be a time delay between a pump pulse and a perturbation observed in the detected signal. Accordingly, in some embodiments step 510 may include finding a thickness value that is substantially proportional to the time delay between the pump pulse and the perturbation in the detected signal.

Further, according to some embodiments, method 500 may include a step to raster scan the high-energy laser beam and the probe radiation along the plane of the substrate. Accordingly, a repetition of at least some of steps 502 through 510 may be performed at a different point on the substrate, thereby providing a map of the material layer thickness.

It is recognized that the various embodiments herein directed to computer control and artificial neural networks, including various blocks, modules, elements, components, methods, and algorithms, can be implemented using computer hardware, software, combinations thereof, and the like. To illustrate this interchangeability of hardware and software, various illustrative modules, elements, components, methods and algorithms have been described generally in terms of their functionality. Whether such functionality is implemented as hardware or software will depend upon the particular application and any imposed design constraints. For at least this reason, it is to be recognized that one of ordinary skill in the art can implement the described functionality in a variety of ways for a particular application. Further, various components and blocks can be arranged in a different order or partitioned differently, for example, without departing from the scope of the embodiments expressly described.

Computer hardware used to implement the various illustrative blocks, modules, elements, components, methods, and algorithms described herein can include a processor configured to execute one or more sequences of commands, programming stances, or code stored on a non-transitory, computer-readable medium. The processor can be, for example, a general purpose microprocessor, a microcontroller, a digital signal processor, an application specific integrated circuit, a field programmable gate array, a programmable logic device, a controller, a state machine, a gated logic, discrete hardware components, an artificial neural network, or any like suitable entity that can perform calculations or other manipulations of data. In some embodiments, computer hardware can further include elements such as, for example, a memory (e.g., random access memory (RAM), flash memory, read only memory (ROM), programmable read only memory (PROM), erasable programmable read only memory (EPROM)), registers, hard disks, removable disks, CD-ROMS, DVDs, or any other like suitable storage device or medium.

Executable sequences described herein can be implemented with one or more sequences of code contained in a memory. In some embodiments, such code can be read into the memory from another machine-readable medium. Execution of the sequences of commands contained in the memory can cause a processor to perform the process steps described herein. One or more processors in a multi-processing arrangement can also be employed to execute instruction sequences in the memory. In addition, hard-wired circuitry can be used in place of or in combination with software instructions to implement various embodiments described herein. Thus, the present embodiments are not limited to any specific combination of hardware and/or software.

As used herein, a machine-readable medium will refer to any medium that directly or indirectly provides commands to a processor for execution. A machine-readable medium can take on many forms including, for example, non-volatile media, volatile media, and transmission media. Non-volatile media can include, for example, optical and magnetic disks. Volatile media can include, for example, dynamic memory. Transmission media can include, for example, coaxial cables, wire, fiber optics, and wires that form a bus. Common forms of machine-readable media can include, for example, floppy disks, flexible disks, hard disks, magnetic tapes, other like magnetic media, CD-ROMs, DVDs, other like optical media, punch cards, paper tapes and like physical media with patterned holes, RAM, ROM, PROM, EPROM and flash EPROM.

Embodiments disclosed herein include:

A. A system that includes a chamber including an assembly to receive an at least partially completed integrated computational element (ICE) device, a first measurement device using surface acoustic waves (SAW) to measure a first film thickness in the ICE device, the first measurement device comprising a pump electromagnetic radiation source configured to provide an excitation pulse at near normal incidence from an outer surface of the ICE device, the excitation pulse generating a SAW on the outer surface, a probe electromagnetic radiation source configured to provide a probe radiation to interact with an outer surface of the ICE device and thereby generate interacted radiation, an optical radiation transducer configured to receive the interacted radiation for an interaction time and generate a signal, and an analyzer configured to receive a time trace of the signal from the optical transducer and to determine a thickness of a material layer on the outer surface of the ICE device.

B. A method that includes depositing a layer of material to form a stack, forming a surface acoustic wave (SAW) on the layer of material, measuring the SAW, obtaining a transform function of a time measurement of the SAW, finding a mechanical property of the layer of material using the transform function and a model, and adjusting a deposition parameter for the layer of material according to the mechanical property, wherein adjusting the deposition parameter includes selecting a thickness of the layer of material in the stack according to a spectroscopic analysis of a characteristic of a substance.

C. A non-transitory, computer readable medium storing commands that, when executed by a processor in a computer unit included in a system for fabricating an integrated computational element (ICE) device, cause the system to perform a method that includes directing a high energy electromagnetic radiation source to a substrate for an interaction period, directing a probe electromagnetic radiation source to interact with a surface of the substrate, detecting an interacted light emerging from the surface of the substrate for a period of time including the interaction period, finding a Fourier transform of the interacted light as a function of time, determining a mechanical property of the substrate based on the Fourier transform, and adjusting a deposition parameter for the layer of material according to the mechanical property and a spectroscopic analysis of a characteristic of a substance.

Each of embodiments A, B, and C may have one or more of the following additional elements in any combination: Element 1: further comprising a second measurement device using at least one of optical monitoring, ellipsometry, quartz monitoring, and optical spectroscopy, the second measurement device configured to measure a second film thickness in the ICE device. Element 2: wherein the analyzer is configured to obtain a Fourier transform of the time trace of the signal, and to determine the thickness of the material layer from at least one Fourier component of the Fourier transform. Element 3: wherein the analyzer provides at least one of a density, a Young's modulus, and a Poisson ratio of the material layer on the outer surface. Element 4: wherein the pump electromagnetic radiation source comprises a mode-locked, ultra-fast laser that provides a plurality of pulses of light at a selected repetition rate. Element 5: wherein the selected repetition rate includes the interaction time between two consecutive pulses of light. Element 6: wherein the optical radiation transducer includes a plurality of optical radiation transducers configured to measure a diffraction pattern of the interacted radiation.

Element 7: wherein finding a mechanical property of the layer comprises finding at least one of a thickness, a density, a Young's modulus, or a Poisson ratio of the layer. Element 8: wherein measuring a SAW comprises measuring an amplitude of the SAW at a point on the layer of material, in time. Element 9: wherein measuring a SAW comprises directing a probe electromagnetic radiation to a point on the layer of material and measuring an interacted radiation emerging from the point on the layer after an interaction time. Element 10: further comprising measuring a property of the layer of material using at least one of quartz crystal microbalance, ellipsometry, spectroscopy, and interferometry. Element 11: wherein obtaining the transform function of the time measurement of the SAW comprises obtaining a Fourier transform of a time measurement of the SAW. Element 12: wherein adjusting the deposition parameter for the layer of material comprises at least one of increasing a deposition rate, reducing the deposition rate, and stopping the deposition of the layer of material. Element 13: further comprising determining that the layer of material is one of an opaque layer of material or a thick layer of material, according to a detection limit of an optical radiation transducer detecting an interacted radiation emerging from the layer of material.

Element 14: further comprising storing commands causing the system to perform directing the high energy electromagnetic radiation source in a plurality of pulses having a repetition rate such that the interaction period is included between two consecutive pulses. Element 15: wherein determining the mechanical property of the substrate comprises determining at least one of a thickness, a density, a Young's modulus, and a Poisson ratio of an outer layer of material in the substrate. Element 16: wherein determining the mechanical property of the substrate comprises using a model that includes at least one of a density, a Young's modulus, and a Poisson ratio of an outer layer of material in the substrate. Element 17: further comprising storing commands causing the system to perform updating the model with at least one of the thickness, the density, the Young's modulus, and the Poisson ratio of the outer layer of material in the substrate. Element 18: further comprising storing commands causing the system to perform determining a property of the substrate based on at least one of a quartz crystal microbalance, an ellipsometry measurement, a spectroscopy measurement, or an interferometry measurement.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A system, comprising:
a chamber including an assembly to receive an at least partially completed integrated computational element (ICE) device;
a first measurement device using surface acoustic waves (SAW) to measure a first film thickness in the ICE device, the first measurement device comprising:
a pump electromagnetic radiation source configured to provide an excitation pulse at near normal incidence from an outer surface of the ICE device, the excitation pulse generating a SAW on the outer surface;
a probe electromagnetic radiation source configured to provide a probe radiation to interact with an outer surface of the ICE device and thereby generate interacted radiation;
an optical radiation transducer configured to receive the interacted radiation for an interaction time and generate a signal; and
an analyzer configured to receive a time trace of the signal from the optical transducer and to determine a thickness of a material layer on the outer surface of the ICE device.

2. The system of claim 1, further comprising a second measurement device using at least one of optical monitoring, ellipsometry, quartz monitoring, and optical spectroscopy, the second measurement device configured to measure a second film thickness in the ICE device.

3. The system of claim 1, wherein the analyzer is configured to obtain a Fourier transform of the time trace of the signal, and to determine the thickness of the material layer from at least one Fourier component of the Fourier transform.

4. The system of claim 1, wherein the analyzer provides at least one of a density, a Young's modulus, and a Poisson ratio of the material layer on the outer surface.

5. The system of claim 1, wherein the pump electromagnetic radiation source comprises a mode-locked, ultra-fast laser that provides a plurality of pulses of light at a selected repetition rate.

6. The system of claim 4, wherein the selected repetition rate includes the interaction time between two consecutive pulses of light.

7. The system of claim 1, wherein the optical radiation transducer includes a plurality of optical radiation transducers configured to measure a diffraction pattern of the interacted radiation.

8. A method, the method comprising:
depositing a layer of material to form a stack;
forming a surface acoustic wave (SAW) on the layer of material;
measuring the SAW;
obtaining a transform function of a time measurement of the SAW;
finding a mechanical property of the layer of material using the transform function and a model; and
adjusting a deposition parameter for the layer of material according to the mechanical property, wherein adjusting the deposition parameter includes selecting a thickness of the layer of material in the stack according to a spectroscopic analysis of a characteristic of a substance.

9. The method of claim 8, wherein finding a mechanical property of the layer comprises finding at least one of a thickness, a density, a Young's modulus, or a Poisson ratio of the layer.

10. The method of claim 8, wherein measuring a SAW comprises measuring an amplitude of the SAW at a point on the layer of material, in time.

11. The method of claim 8, wherein measuring a SAW comprises directing a probe electromagnetic radiation to a point on the layer of material and measuring an interacted radiation emerging from the point on the layer after an interaction time.

12. The method of claim 8, further comprising measuring a property of the layer of material using at least one of quartz crystal microbalance, ellipsometry, spectroscopy, and interferometry.

13. The method of claim 8, wherein obtaining the transform function of the time measurement of the SAW comprises obtaining a Fourier transform of a time measurement of the SAW.

14. The method of claim 8, wherein adjusting the deposition parameter for the layer of material comprises at least one of increasing a deposition rate, reducing the deposition rate, and stopping the deposition of the layer of material.

15. The method of claim 8, further comprising determining that the layer of material is one of an opaque layer of material or a thick layer of material, according to a detection limit of an optical radiation transducer detecting an interacted radiation emerging from the layer of material.

16. A non-transitory, computer readable medium storing commands that, when executed by a processor in a computer unit included in a system for fabricating an integrated computational element (ICE) device, cause the system to perform a method comprising:
directing a high energy electromagnetic radiation source to a substrate for an interaction period;
directing a probe electromagnetic radiation source to interact with a surface of the substrate;
detecting an interacted light emerging from the surface of the substrate for a period of time including the interaction period;
finding a Fourier transform of the interacted light as a function of time;
determining a mechanical property of the substrate based on the Fourier transform; and
adjusting a deposition parameter for the layer of material according to the mechanical property and a spectroscopic analysis of a characteristic of a substance.

17. The non-transitory, computer readable medium of claim 16, further comprising storing commands causing the system to perform directing the high energy electromagnetic radiation source in a plurality of pulses having a repetition rate such that the interaction period is included between two consecutive pulses.

18. The non-transitory, computer readable medium of claim 16, wherein determining the mechanical property of the substrate comprises determining at least one of a thickness, a density, a Young's modulus, and a Poisson ratio of an outer layer of material in the substrate.

19. The non-transitory, computer readable medium of claim 16, wherein determining the mechanical property of the substrate comprises using a model that includes at least one of a density, a Young's modulus, and a Poisson ratio of an outer layer of material in the substrate.

20. The non-transitory, computer readable medium of claim 19, further comprising storing commands causing the system to perform updating the model with at least one of the thickness, the density, the Young's modulus, and the Poisson ratio of the outer layer of material in the substrate.

21. The non-transitory, computer readable medium of claim 16, further comprising storing commands causing the system to perform determining a property of the substrate based on at least one of a quartz crystal microbalance, an ellipsometry measurement, a spectroscopy measurement, or an interferometry measurement.
